(19) United States
(12) Patent Application Publication
(10) Pub. No.: US 2005/0107984 A1
(43) Pub. Date: May 19, 2005

(54) Manufacturing apparatus and method for predicting life of rotary machine used in the same

(75) Inventors: Shuichi Samata, Kanagawa-ken (JP); Yukihiro Ushiku, Kanagawa-ken (JP); Takashi Nakao, Kanagawa-ken (JP); Takeo Furuhata, Mie-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/020,477

(22) Filed: Dec. 27, 2004

Related U.S. Application Data
(63) Continuation of application No. 10/366,022, filed on Feb. 12, 2003, now Pat. No. 6,868,760.

(30) Foreign Application Priority Data
Sep. 30, 2002 (JP) P2002-287944

(51) Int. Cl. G06F 11/30

(52) U.S. Cl. 702/183

(57) ABSTRACT

A method for predicting life of a rotary machine used in a manufacturing apparatus, includes: determining a starting time of an abnormal condition just before a failure of a monitor rotary machine used in a monitor manufacturing process, from monitor time-series data for characteristics of the monitor rotary machine, statistically analyzing the monitor time-series data, and finding a value for the characteristics at the starting time of the abnormal condition as a threshold of the abnormal condition; measuring diagnosis time-series data for the characteristic of a motor current of a diagnosis rotary machine during a manufacturing process; preparing diagnosis data from the diagnosis time-series data; and determining a time for the diagnosis data exceeding the threshold as the life of the diagnosis rotary machine.

### CROSS REFERENCE TO RELATED APPLICATIONS

This application is based upon and claims the benefit of priority from prior Japanese Patent Application P2002-287944 filed on Sep. 30, 2002; the entire contents of which are incorporated by reference herein.

### BACKGROUND OF THE INVENTION

1. Field of the Invention

The present invention relates to prediction and diagnostic techniques regarding the life of a rotary machine used in a manufacturing apparatus. In particular, it relates to a method for predicting the life span of a rotary machine such as a dry pump and a manufacturing apparatus including the rotary machine.

2. Description of the Related Art

Failure diagnosis has become important to ensure efficient semiconductor device manufacturing. In recent years, especially as the trend towards many item/small volume production of system LSI grows, an efficient yet highly adaptable semiconductor device manufacturing method has become necessary. It is possible to use a small-scale production line for efficient production of semiconductors. However, if the large-scale production line is merely shortened, investment efficiency may be reduced because of problems such as a drop in manufacturing apparatus capacity utilization. To rectify this situation, there is a method whereby a plurality of manufacturing processes are performed by one piece of manufacturing apparatus. For example, in LPCVD apparatus using a dry pump for the evacuation system, reactive gases and reaction products differ and formation situations for the reaction products within the dry pump differ depending on the type of manufacturing processes. Therefore, the manufacturing process affects the life of the dry pump.

If the dry pump should have a failure during a specific manufacturing process, then the lot being processed becomes defective. Moreover, excessive maintenance of the manufacturing apparatus may become necessary due to microscopic dust caused by residual reactive gases within the manufacturing apparatus. Implementation of such excessive maintenance causes the manufacturing efficiency of the semiconductor device to drop dramatically. If regular maintenance is scheduled with a margin of safety in order to prevent such sudden failures during the manufacturing process, the frequency of maintenance work on the dry pump may become astronomical. Not only does this increase maintenance costs, but also the decrease in capacity utilization of the semiconductor manufacturing apparatus is conspicuous due to changing the dry pump, causing the manufacturing efficiency of the semiconductor device to decline sharply. In order to use the semiconductor manufacturing apparatus in common for a plurality of processes, as is necessary for an efficient small-scale production line, it is desirable to accurately diagnose vacuum pump life and to operate the dry pump without having any waste in terms of time.

Previously, some methods of diagnosing dry pump life have been proposed. Basically, a state of the dry pump may be monitored by characteristics such as the motor current, vibration, and temperature, and methods have been provided to predict life from changes in these characteristics (refer to Japanese Patent Application P2000-283056). In particular, dry pump life diagnosis methods have been proposed whereby deviation from a reference value for a plurality of characteristics is analyzed using neural networks (refer to Japanese Patent Application P2000-64964).

In the case of performing life prediction with transitions in a motor current of the dry pump, sensitive, accurate and stable life prediction is difficult because of variations in process conditions such as gas flow, or power supply.

### SUMMARY OF THE INVENTION

A first aspect of the present invention inheres in a method for predicting life of a rotary machine used in a manufacturing apparatus, includes: determining a starting time of an abnormal condition just before a failure of a monitor rotary machine used in a monitor manufacturing process, from monitor time-series data for characteristics of the monitor rotary machine, statistically analyzing the monitor time-series data, and finding a value for the characteristics at the starting time of the abnormal condition as a threshold of the abnormal condition; measuring diagnosis time-series data for the characteristic of a motor current of a diagnosis rotary machine during a manufacturing process; preparing diagnosis data from the diagnosis time-series; and determining a time for the diagnosis data exceeding the threshold as the life of the diagnosis rotary machine.

A second aspect of the present invention inheres in a manufacturing apparatus using a rotary machine, includes: a diagnosis rotary machine performing a manufacturing process; a measurement unit configured to measure diagnosis time-series data for characteristics of a motor current of the diagnosis rotary machine during the manufacturing process; and a data processing unit configured to prepare diagnosis data from the diagnosis time-series data, and determine a time for the diagnosis data exceeding the threshold found statistically from a monitor time-series data for characteristics of a monitor rotary machine, as a life of the diagnosis rotary machine.

### BRIEF DESCRIPTION OF DRAWINGS

FIG. 1 is a schematic diagram of a semiconductor manufacturing apparatus according to an embodiment of the present invention;

FIG. 2 is a cross-sectional diagram showing an internal configuration of a rotary machine as a dry pump shown in FIG. 1;

FIG. 3 is a graph showing an example of the change over time of the motor current;

FIG. 4 is a graph showing an example of the change over time of the motor current during a film deposition step;

FIG. 5 is a graph showing another example of the change over time of the motor current during a film deposition step;

FIG. 6 is a boxplot of the maximum motor currents in normal and abnormal conditions;

FIG. 7 is a boxplot of the number of small peaks of the motor current in normal and abnormal conditions;

FIG. 8 is a boxplot of the number of large peaks of the motor current in normal and abnormal conditions;

FIG. 9 is a flowchart for describing a life prediction method for a rotary machine used in a semiconductor manufacturing apparatus according to the embodiment of the present invention; and

FIG. 10 is a block diagram showing a structural example of a semiconductor manufacturing system performing life prediction of a rotary machine according to another embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

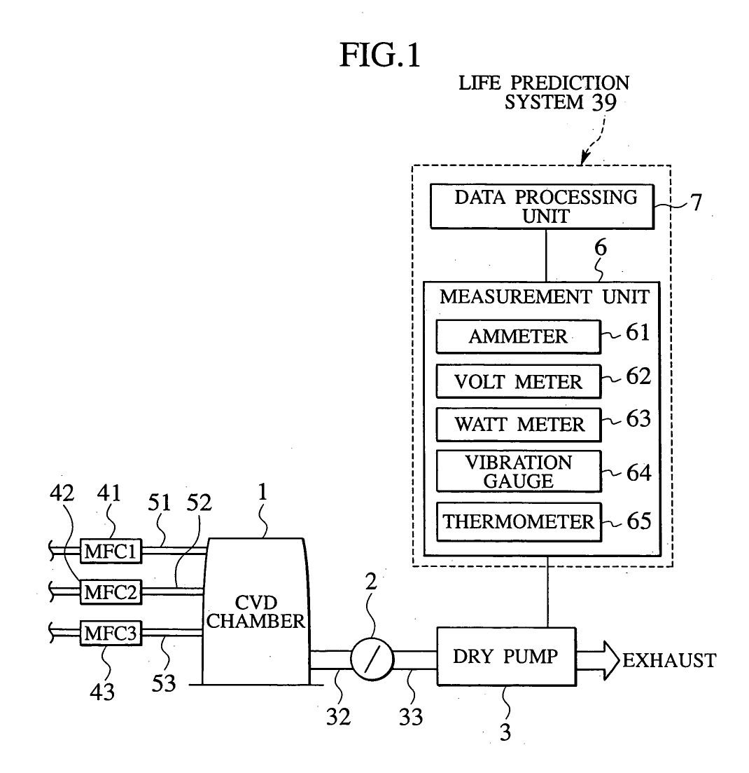

A low-pressure chemical vapor deposition (LPCVD) apparatus as a semiconductor manufacturing apparatus according to an embodiment of the present invention, as shown in FIG. 1, includes a dry pump 3 as a rotary machine for evacuating a CVD chamber 1, and a life prediction system 39 for predicting a life span of the dry pump 3.

The life prediction system 39 includes a measurement unit 6 measuring a variety of characteristics of the dry pump 3, and a data processing unit 7 configured to predict the life of the dry pump 3 by generating time-series data for the characteristics as diagnosis data.

Furthermore, the measurement unit 6 includes an ammeter 61, a voltmeter 62, and a wattmeter 63 to measure a motor current, a motor voltage, and a motor power of the dry pump 3, respectively, and a vibration gauge 64 measuring vibrations and a thermometer 65 monitoring temperature, both of which are attached to the body of the dry pump 3. In the embodiment of the present invention, the life span of the dry pump 3 is diagnosed and predicted mainly by measuring transitions in the motor current of the dry pump 3. The motor current measured by the ammeter 61 is converted into a small signal by the measurement unit 6, and then output to the data processing unit 7. In the data processing unit 7, life diagnosis is performed by subjecting the small signal to analog-to-digital conversion and generating time-series data for the characteristics of the motor current as diagnosis data.

In the LPCVD apparatus, gas pipings 51, 52, and 53 are connected to a CVD chamber 1. These gas pipings 51, 52, and 53 are connected to mass flow controllers 41, 42, and 43, respectively, which control various source gases and carrier gas introduced into the CVD chamber 1. More specifically, source gases and the like having their flow controlled by mass flow controllers 41, 42, and 43 are introduced into the CVD chamber 1 under fixed low-pressure conditions via gas pipings 51, 52, and 53. The CVD chamber 1 has an air-tight structure capable of shutting out outside air and maintaining an atmosphere. In order to evacuate the CVD chamber 1 using a dry pump 3, vacuum piping 32 is connected to the exhaust side of the CVD chamber 1, and a gate valve 2 is connected to the exhaust side of the vacuum piping 32. Another vacuum piping 33 is further connected to the exhaust side of the gate valve 2. The intake side of the dry pump 3 is connected to the exhaust side of the vacuum piping 33. The gate valve 2 may be a valve for either separating the CVD chamber 1 and dry pump 3 or for adjusting exhaust conductance, as circumstances require. In addition, the dry pump 3 is used for evacuating non-reactant source gases and reaction products introduced into the CVD chamber 1.

For example, in the case of depositing a silicon nitride film (Si₃N₄ film) using the LPCVD apparatus shown in FIG. 1, hexachlorodisilane (Si₂Cl₆) gas and ammonia (NH₃) gas are respectively introduced via the mass flow controllers 41 and 42 into the CVD chamber 1 under low-pressure conditions. Inside the CVD chamber 1, a silicon (Si) substrate is heated to approximately 800° C., and through the chemical reaction of the hexachlorodisilane gas and ammonia gas, a silicon nitride film is deposited upon the silicon substrate. In addition to generating the silicon nitride film, this reaction produces reaction by-products of ammonium chloride (NH₄Cl) gas and hydrogen (H₂) gas. Since hydrogen is a vapor, it can be evacuated through the dry pump 3. On the other hand, since the temperature of the silicon substrate within the reactor is approximately 800° C. and it is under low-pressure of approximately several 100 Pa or less at the time of formation, the ammonium chloride is also in a vapor phase. While it is omitted from the drawings, LPCVD apparatus typically has a trap disposed between the CVD chamber 1 and the dry pump 3 for collecting solid reaction by-products. With this trap, it is impossible to completely collect the reaction by-product under low-pressure conditions. The reaction by-product that is not collected reaches the dry pump 3. Pressure in the dry pump 3 increases from approximately 0.1 Pa to normal atmospheric pressure due to the compression of the gas. The reaction by-product is in a vapor phase under low-pressure conditions, and begins to solidify in accordance with the sublimation curve of the phase diagram as pressure increases. Within the dry pump 3, since the pressure changes from several 100 Pa of pressure to normal atmospheric pressure by repeating compression of the gas, the gaseous reaction by-product within the exhaust gas begins to solidify in the dry pump 3 as the pressure increases. If solidification begins in the piping of the dry pump 3, although it is a minute amount, the deposited material causes the elastic deformation of a rotational axis of the dry pump 3. This effect results in dry pump failure.

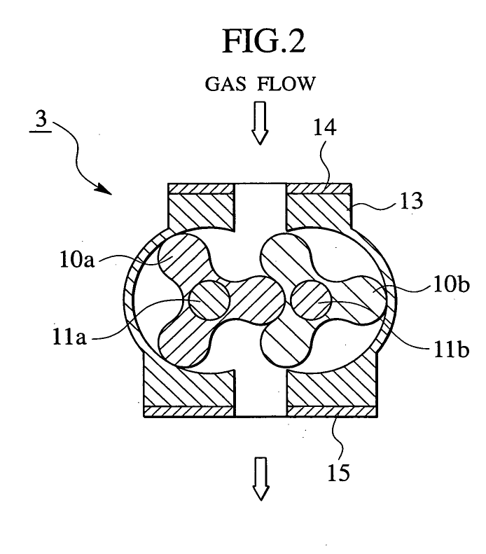

As shown in FIG. 2, the dry pump 3 used in the LPCVD apparatus according to the embodiment is constructed with two three-bladed rotors 10a and 10b, which rotate around rotational axes 11a and 11b, respectively. The dry pump 3 includes a body 13, a suction flange 14 provided on a suction side of the body 13, and an exhaust flange 15 provided on an exhaust side of the body 13. The gas flow coming from the CVD chamber 1 via the gate valve 2 enters the dry pump 3 through the suction flange 14. The gas that enters the dry pump 3 is compressed through the rotation of the two rotors 10a and 10b around the rotational axes 11a and 11b. The compressed gas is evacuated through the exhaust flange 15.

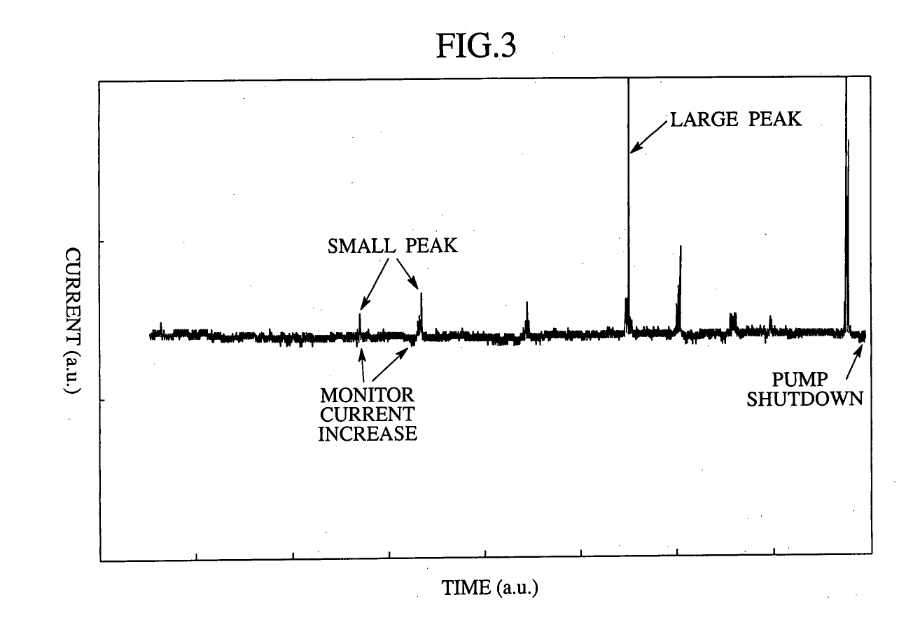

The rotors 10a and 10b are rotated by a motor. When using the rotors 10a and 10b in a state where the reaction by-product is generated inside the dry pump 3, if the accumulated amount of the reaction by-product exceeds a certain limit, the reaction by-product rubs between the rotors 10a and 10b, or between the rotors 10a, 10b and an inner wall of the body 13, the rotors 10a, 10b finally fail. Even when the accumulated amount of the reaction by-product is not enough to cause failure of the rotors 10a, 10b, motor current increases since the motor load is increased. The more the accumulated amount of the reaction by-product inside the dry pump 3 increases, the larger the increment in motor current becomes. Regarding the transitions in motor current after the accumulation of the reaction by-product, as shown in FIG. 3, large and small current peaks can be observed, in addition to the increment of the motor current during a film deposition step. Numbers of current peaks increase along with the increase in the accumulated amount of the reaction by-product. Specifically, large peaks in the motor current suddenly increase just before pump shutdown. When the accumulated amount of the reaction by-product increases, since a phenomenon occurs in which a large lump thereof between the inner wall of the body 13 and the rotors 10a, 10b is crushed, the motor current increases in a short time, and a current peak can be observed. A given length of time prior to a failure of the dry pump 3 is defined as an abnormal condition period, and before that is the normal condition period, when the dry pump 3 works in a normal condition. A boundary between the normal condition and the abnormal condition in terms of characteristics such as the increment and number of current peaks of the motor current can be found by applying a statistical method, and can be used as a threshold of life determination. In this manner, the life of the dry pump 3 caused by a blockage of the reaction by-product may be predictable.

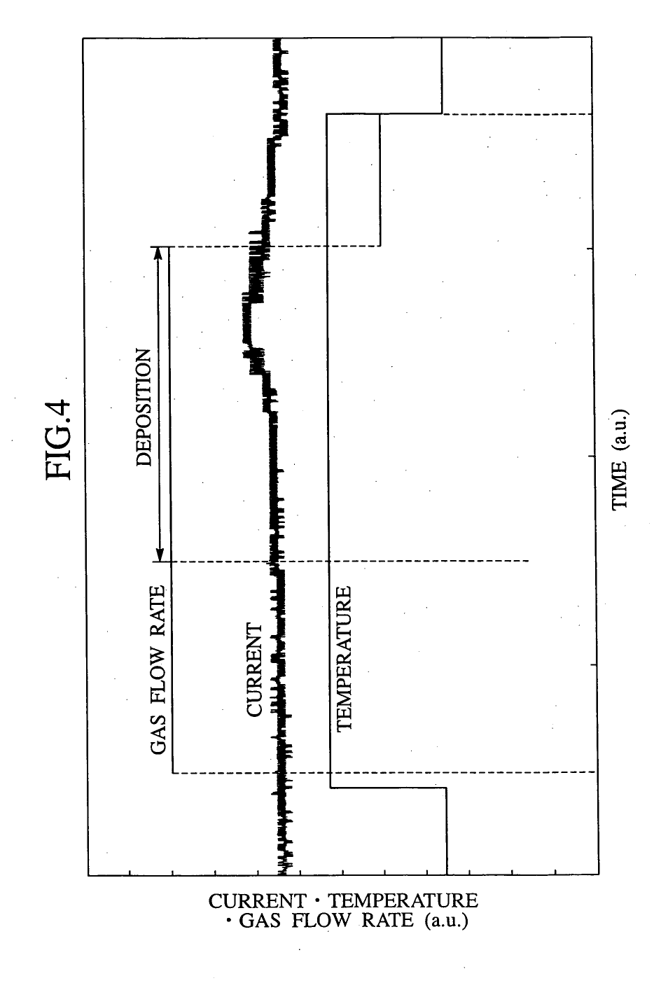

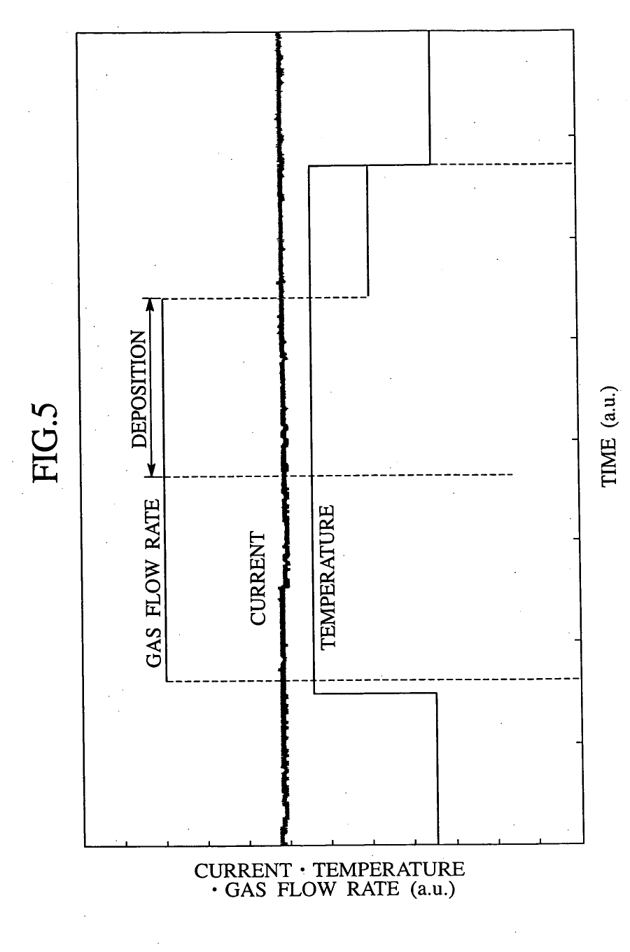

The increment of the motor current during the film deposition step develops after a certain length of time depending on film deposition conditions such as gas species, gas flow rates, or deposition temperature. Resulting from the measured transitions in motor current of the dry pump 3 under the film deposition conditions of, for example, Si₂Cl₆ gas: 50 sccm, NH₃ gas: 1000 sccm, and deposition temperature: 650° C., as shown in FIG. 4, an increment in the motor current of the dry pump 3 is confirmed ten minutes after reaction gases flow into the CVD chamber 1. In the example shown in FIG. 4, more than several μm of the reaction by-product is already accumulated inside the dry pump 3. On the other hand, in the film deposition conditions under which the film deposition is completed in a short time, as shown in FIG. 5, the increment in the motor current is not observed during the film deposition step. Accordingly, in the case where the increment in the motor current is used as life diagnosis data, measured data for the motor current during a film deposition step that is longer than a predetermined time period, may be adopted.

The characteristics of motor current that can be used for the life prediction include a maximum current in the increment, a total value of the increment, a number of the current peaks and the like during the film deposition step. Since the transitions in an occurrence frequency of the current peaks differs according to peak heights, the current peaks are categorized into “large peaks” and “small peaks” on the basis of a fixed value, for use as life diagnosis data. Furthermore, the motor current is affected by variation in power supply. In order to remove an effect of variation in power supply, the motor voltage and the motor power are measured in parallel with the motor current by the voltmeter 62 and the wattmeter 63, respectively. The variation in the motor current, which is synchronous with the variation in voltage or power, is eliminated as an effect of the variation in the power supply.

A method to determine the thresholds used as the determination reference is important in the life diagnosis of the dry pump 3. Values at the time point where the variation in the motor current becomes large are usually used as the thresholds. In the data shown in FIG. 4, the increasing speed of the maximum currents arises from two days before the failure of the dry pump 3. Therefore, for example, the maximum current of three days before the failure of the dry pump 3 is given as the threshold. For film deposition steps that require film deposition over ten minutes long in which the increment in the motor current is recognized, the time-series data for the maximum currents of the dry pump 3 are measured until the dry pump 3 shuts down. As a result, the maximum current in the characteristics is found to exceed the threshold more than one week before the failure of the dry pump 3.

In addition to the above method of deciding the threshold from the variation in the motor current, it is possible to decide the threshold by setting a fixed period of time before the failure of the dry pump 3 due to the blockage of the reaction by-product as the abnormal condition, and the period before that as in the normal condition. Using a statistical method, the values of the characteristics at the boundary between the abnormal condition and normal condition may be found accurately. For example, in the case where the characteristics of the motor current change greatly before the failure of the dry pump 3, by making the period after this change to be the abnormal condition, and setting the boundary with the normal condition, accuracy may be further improved. The threshold for the characteristics at the boundary between the normal condition and abnormal condition should be found by a statistical method such as a Mahalanobis distance (MD). The key to applying the MD lies in forming a reference space (Mahalanobis space). In the embodiment of the present invention, the Mahalanobis space is formed using not only the variations in the motor current as the characteristics during the LPCVD film deposition step, but also time-series data such as the voltage of the motor, the power of the motor, vibrations, and temperature of the dry pump 3. For example, the effects of variations in the film deposition conditions for evaluating the condition of the dry pump 3 may be eliminated by investigating the transition of changes in the MD during a three day period using the time-series data for the characteristics measured three days previously as “reference time-series data”.

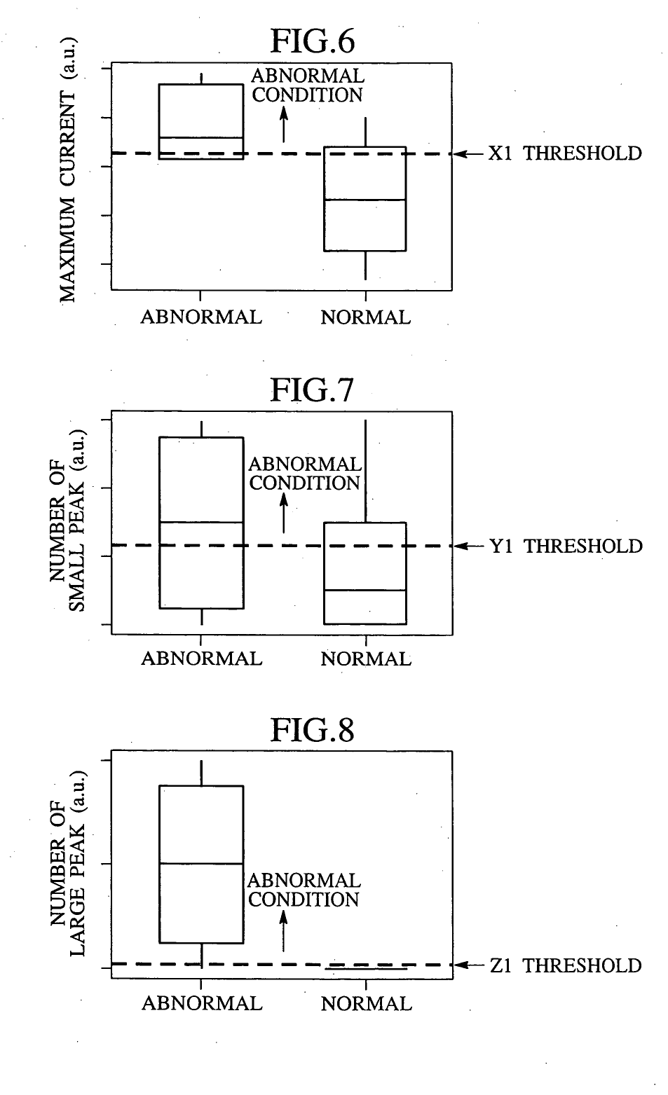

A threshold X1 for the maximum current of the motor current during the film deposition step is found using the Mahalanobis distance. Here, the boundary between the normal condition and abnormal condition of the dry pump 3 is given as two days before the failure of the dry pump 3, which is when the increment in the motor current becomes prominent. In the same way, thresholds Y1 and Z1 for the number of small peaks and large peaks of the motor current during the film deposition step, respectively, are found using the Mahalanobis distance. In FIG. 6 through FIG. 8, distribution of the maximum currents, the number of small peaks and the number of large peaks under normal conditions and abnormal conditions are shown using boxplots. It can be understood that the medians of any of the distributions of the maximum currents, the number of small peaks and the number of large peaks are below the threshold X1, Y1 and Z1, under normal conditions, and exceed the threshold X1, Y1 and Z1, under abnormal conditions. In this manner, the diagnosis or the prediction of the life of the dry pump 3 is possible using the threshold determined using the MD. Regarding the maximum currents and the number of the small peaks, as shown in FIG. 6 and FIG. 7, the third quartiles of the normal conditions exceed the thresholds X1 and Y1, respectively, and the first quartiles of the abnormal conditions are less than the thresholds X1 and Y1, respectively. The maximum currents and the number of the small peaks are confirmed to actually exceed the thresholds X1 and Y1 for determining the abnormal condition, four days and one week before the failure of the dry pump 3. On the other hand, as shown in FIG. 8, it can be understood that large peaks are not found under normal conditions, but suddenly increase under abnormal conditions. The number of large peaks exceeds a threshold Z1 within two days before the failure of the dry pump 3.

The accumulation of the reaction by-product inside the dry pump 3 does not uniformly increase, thus the variations in the maximum current, the number of the small peaks and the number of the large peaks of the motor current occur. Consequently, accuracy in predicting the life of the dry pump 3 differs depending on the method of setting the threshold and the characteristics given as analysis targets. For example, with the number of the small peaks in FIG. 7, the boundary between the abnormal condition and the normal condition is unclear, and a first type of error risk rate (α risk) used for a test is equal to or more than 5%, and a second type of error risk rate (β risk) is equal to or more than 10%. Consequently, it has a high probability to determine erroneously as the abnormal condition, since the diagnosis data of the number of the small peaks under the normal conditions exceeds the threshold.

Accordingly, using the number of small peaks, an indication of abnormality may be captured by monitoring the accumulated state of the reaction by-product inside the dry pump 3, and using characteristics such as the number of large peaks, which mark the boundary between normal condition and abnormal condition clearly, the life of the dry pump 3 may be determined. Therefore, the accuracy of life span prediction is further increased. In the embodiment of the present invention, the life prediction of the dry pump 3 from two days to one week before failure becomes possible by using three kinds of characteristics as the diagnosis data, the maximum current, the number of small peaks and the number of large peaks of the motor current during the film deposition step, and finding the threshold for the abnormal condition from the MD.

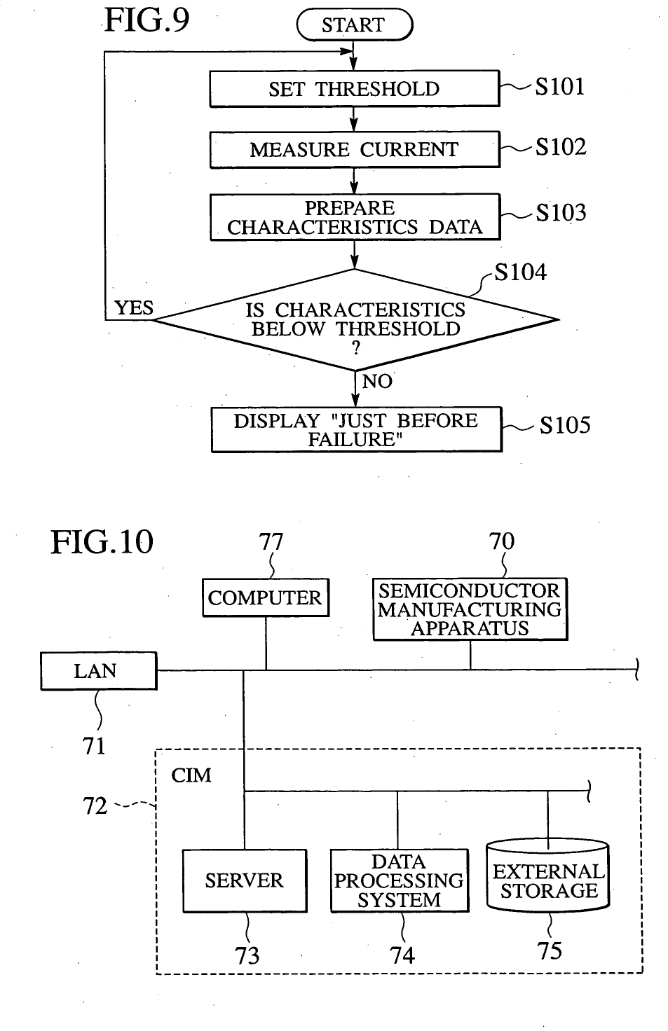

Next, using the flowchart shown in FIG. 9, the life prediction method for the rotary machine used in the manufacturing apparatus according to the embodiment of the present invention is described. More specifically, the life is predicted for the dry pump 3 utilized in the LPCVD apparatus that forms a Si₃N₄ film.

(a) To begin with, in step S101, thresholds for an abnormal condition utilized in the life prediction of the dry pump 3 in the LPCVD apparatus are set. In calculation of the thresholds, monitor time-series data of a motor current measured on a monitor dry pump (monitor rotary machine) is used. The thresholds for the abnormal condition of maximum currents, a number of small peaks and a number of large peaks in monitor film deposition steps are found using the MD.

(b) Next, in step S102, diagnosis time-series data of a motor current during a film deposition step of a diagnosis dry pump (diagnosis rotary machine) 3 is sampled and measured by the ammeter 61. The sampling interval is, for example, one second. The motor current measured by the ammeter 61 is converted into a small signal by the measurement unit 6 and output to the data processing unit 7.

(c) In step S103, in the data processing unit 7, the small signal is subjected to analog-to-digital conversion so as to prepare diagnosis data from the diagnosis time-series data for characteristics. The characteristics are maximum currents, a number of small peaks, and a number of large peaks, for example.

(d) Thereafter, in step S104, the life of the diagnosis dry pump 3 is determined by the data processing unit 7 comparing the diagnosis data with the thresholds. Measurement is repeated if all of the diagnosis data is below the thresholds. Furthermore, in the case where one or both of the number of small peaks and the maximum current exceed the thresholds, considered as an indication of abnormality, the measurement is also repeated.

(e) In the case where the diagnosis data for the number of small peaks, the maximum currents and the number of large peaks exceed the corresponding thresholds, respectively, in step S105, the life prediction system 3 then displays an indication on a display device or display panel, or with a display lamp attached to the LPCVD apparatus showing that the pump is just before failure (life).

According to the life prediction method of the semiconductor manufacturing apparatus of the embodiment of the present invention, the indication of abnormality and the life of the dry pump 3 can be determined with high sensitivity, stability and accuracy.

### Other Embodiments

The present invention has been described as mentioned above, however the descriptions and drawings that constitute a portion of this disclosure should not be perceived as limiting this invention. Various alternative embodiments and operational techniques will become clear to persons skilled in the art from this disclosure.

In the embodiment of the present invention, the MD is used for deciding the boundary between the abnormal conditions and the normal conditions; however, similar effects may be obtained using another statistical method such as a t-test or a χ²-test or the like.

Furthermore, in the embodiment of the present invention, the analysis for predicting the life of the dry pump 3 is performed by the data processing unit 7 of the life prediction system 39 attached to the LPCVD apparatus, however, the life prediction analysis may be performed by another computer in the LPCVD apparatus. For example, it may be embedded in a controller (not shown in the figures) of the dry pump 3. Furthermore, as shown in FIG. 10, a semiconductor manufacturing system according to another embodiment of the present invention provides a semiconductor manufacturing apparatus 70, a computer 77, and a computer integrated manufacturing system (CIM) 72 and the like connected to a local area network (LAN) 71. The CIM 72 has a server 73, a data processing system 74 and an external storage unit 75 and the like connected thereto. The life determination analysis may also be performed by the data processing system 74 on the CIM by transmitting measured time-series data via the LAN 71. Furthermore, the life determination analysis may also be performed by the computer 77 on the LAN 71, the server 73 or another computer on the CIM 72. Moreover, storing the time-series data for the characteristics used in the life determination analysis in the external storage unit 75 on the CIM 72 is also allowable.

Furthermore, in the above description, the case where a Si₃N₄ film is deposited through a reaction of Si₂Cl₆ gas and NH₃ gas is given, however, naturally, source gases are not limited to Si₂Cl₆ gas and NH₃ gas. For example, dichlorosilane (SiH₂Cl₂) gas and the like may be used instead of Si₂Cl₆ gas.

Moreover, the example of LPCVD for Si₃N₄ film should not be construed as limiting; LPCVD for thin films with other materials is similarly applicable. In addition, an example where a single type of thin film is grown is shown, however, similar effects may be obtained in the case of forming a thin film having a plurality of species, such as a SiO₂ film, TEOS oxide film, and polycrystalline silicon with the same LPCVD apparatus.

In addition, in the descriptions of the embodiment, a Roots-type dry pump 3 is illustrated as an example of a rotary machine, however, it has been verified that similar results may be obtained with a screw-type dry pump. Moreover, a rotary machine such as a turbo-molecular pump, a mechanical booster pump, or a rotary pump is also allowable.

It should be noted that an example of an LPCVD process is illustrated in the embodiment. In the present invention similar results have been confirmed in the case where the reaction product is deposited inside the dry pump resulting in the pump shutting down and may be applicable to CVD processes in general and also such as the dry etching process.

Various modifications will become possible for those skilled in the art after receiving the teachings of the present disclosure without departing from the scope thereof.

1. A method for predicting life of a rotary machine used in a manufacturing apparatus, comprising:
determining a starting time of an abnormal condition just before a failure of a monitor rotary machine used in a monitor manufacturing process, from monitor time-series data for characteristics of the monitor rotary machine, statistically analyzing the monitor time-series data, and finding a value for the characteristics at the starting time of the abnormal condition as a threshold of the abnormal condition;
measuring diagnosis time-series data for the characteristic of a motor current of a diagnosis rotary machine during a manufacturing process;
preparing diagnosis data from the diagnosis time-series data; and
determining a time for the diagnosis data exceeding the threshold as the life of the diagnosis rotary machine.

2. The method of claim 1, wherein the threshold is determined using a Mahalanobis distance obtained from the monitor time-series data.

3. The method of claim 2, wherein the characteristic of the motor current includes a number of current peaks generated in the manufacturing process.

4. The method of claim 3, wherein the diagnosis data is prepared using a plurality of the characteristics having a different error risk rate misdiagnosed as the abnormal condition due to the diagnosis data exceeding the threshold under a normal condition prior to entering the abnormal condition.

5. The method of claim 4, wherein variations in the motor current due to a power supply are selected by monitoring at least one of a motor voltage and a motor power of the diagnosis rotary machine.

6. The method of claim 1, wherein the characteristic of the motor current includes a number of current peaks generated in the manufacturing process.

7. The method of claim 6, wherein the diagnosis data is prepared using a plurality of the characteristics having a different error risk rate misdiagnosed as the abnormal condition due to the diagnosis data exceeding the threshold under a normal condition prior to entering the abnormal condition.

8. The method of claim 7, wherein variations in the motor current due to a power supply are selected by monitoring at least one of a motor voltage and a motor power of the diagnosis rotary machine.

9. The method of claim 1, wherein the diagnosis data is prepared using a plurality of the characteristics having a different error risk rate misdiagnosed as the abnormal condition due to the diagnosis data exceeding the threshold under a normal condition prior to entering the abnormal condition.

10. The method of claim 9, wherein variations in the motor current due to a power supply are selected by monitoring at least one of a motor voltage or a motor power of the diagnosis rotary machine.

11. The method of claim 1, wherein variations in the motor current due to a power supply are selected by monitoring at least one of a motor voltage and a motor power of the diagnosis rotary machine.

12. A manufacturing apparatus using a rotary machine, comprising:
a diagnosis rotary machine performing a manufacturing process;
a measurement unit configured to measure diagnosis time-series data for characteristics of a motor current of the diagnosis rotary machine during the manufacturing process; and
a data processing unit configured to prepare diagnosis data from the diagnosis time-series data, and determine a time for the diagnosis data exceeding the threshold found statistically from a monitor time-series data for characteristics of a monitor rotary machine, as a life of the diagnosis rotary machine.

13. The manufacturing apparatus of claim 12, wherein the measurement unit includes at least one of a voltmeter measuring a motor voltage and a wattmeter measuring a motor power, for the diagnosis rotary machine.

14. The manufacturing apparatus of claim 13, wherein the diagnosis rotary machine is a dry pump used in a semiconductor manufacturing apparatus.

15. The manufacturing apparatus of claim 14, wherein the data processing unit is provided to a computer on a local area network.

16. The manufacturing apparatus of claim 14, wherein the data processing unit is provided to a data processing system on a computer integrated manufacturing system.

17. The manufacturing apparatus of claim 12, wherein the diagnosis rotary machine is a dry pump used in a semiconductor manufacturing apparatus.

18. The manufacturing apparatus of claim 17, wherein the data processing unit is provided to a computer on a local area network.

19. The manufacturing apparatus of claim 12, wherein the data processing unit is provided to a computer on a local area network.

20. The manufacturing apparatus of claim 12, wherein the data processing unit is provided to a data processing system upon a computer integrated manufacturing system.
